(19) United States
(12) Patent Application Publication
(10) Pub. No.: US 2014/0329604 A1
(43) Pub. Date: Nov. 6, 2014

(54) TRANSPORT AGNOSTIC IPC MECHANISM

(71) Applicant: BALLY GAMING, INC., LAS VEGAS, NV (US)

(72) Inventors: Nathan K. Harvey, Pahrump, NV (US); Pravinkumar Patel, Las Vegas, NV (US); Patrick Spiller, Las Vegas, NV (US); Joshua Larsen, Bellevue, WA (US)

(73) Assignee: BALLY GAMING, INC., LAS VEGAS, NV (US)

(21) Appl. No.: 14/258,367

(22) Filed: Apr. 22, 2014

Related U.S. Application Data
(60) Provisional application No. 61/818,786, filed on May 2, 2013.

(51) Int. Cl. H04L 29/08; A63F 13/30

(52) U.S. Cl. CPC H04L 67/10; A63F 13/12
USPC 463/42; 709/203

(57) ABSTRACT

A distributed computer system includes at least two processors. Each processor includes at least one process including at least one thread and a network server. A host module is in a thread in a first processor and a client module is in a thread in a second processor. A network couples the respective network servers in the processors. The host module registers with the system via the network server in the first processor. The client module on the second processor establishes a connection with the host module on the first processor. The host module and the client module communicate through the established connection.

### CROSS REFERENCE TO RELATED APPLICATION

This application is a non-provisional filing from and claims priority to U.S. Provisional Application Ser. No. 61,818,786 filed May 2, 2013 and titled “Transport Agnostic IPC Mechanism.”

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

1. Field of the Invention

The present invention relates to communication mechanisms between executing computer programs, and in particular to communication mechanisms between computer programs executing on different threads, processes or processors where modules are not guaranteed to be consistent.

2. The Prior Art

Current computer systems may require communications between or among multiple threads in one or more processes running on a processor. Further, processes may be running on one or more processors connected by a network. ‘Inter-process communication’ (IPC) is a set of methods which may be used to carry out such communication. (IPC may also be referred to as inter-thread communication and inter-application communication.) Such methods may be divided into methods for message passing, synchronization, shared memory, and remote procedure calls (RPC). The particular IPC mechanism selected may vary based on the bandwidth and latency of communication between the threads, and the type of data being communicated.

One such method is to use memory shared between or among the multiple threads in a process on a processor, a method known as ‘shared memory’. Shared memory is memory which may be simultaneously accessed by multiple threads in a process to enable communication of data among them and to avoid having to maintain redundant copies of the data. This memory is accessible by all threads in the process. One thread stores data in the shared memory, and a different thread retrieves the data from the shared memory. Other IPC mechanisms include: files, signals, sockets, message queues, pipes, named pipes, semaphores, message passing, and memory mapped files. Further methods also exist.

However, as computer systems become more complex, threads and processes may be located on different machines which, in turn, may be located at different sites. Such a system does not allow for a shared memory IPC mechanism. Further the other IPC mechanisms may not be able to provide the performance required of such a system.

An IPC mechanism which can operate efficiently among multiple threads on one or more processes located on one or more computers, while providing sufficient performance to satisfy a complex interoperable computer application is desirable.

### BRIEF DESCRIPTION OF THE INVENTION

In accordance with principles of the present invention, a distributed computer system includes at least two processors. Each processor includes at least one process including at least one thread and a network server. A host module is in a thread in a first processor and a client module is in a thread in a second processor. A network couples the respective network servers in the processors. The host module registers with the system via the network server in the first processor. The client module on the second processor establishes a connection with the host module on the first processor. The host module and the client module communicate through the established connection.

### BRIEF DESCRIPTION OF THE DRAWING

FIG. 1 is a schematic diagram illustrating the relationships among processors, processes within the processors, threads within the processes, and modules within threads;

FIG. 2 Error! Reference source not found. is a schematic diagram of processors showing the interconnection of the software components for implementing an inter-process communication technique which is operable across processors;

FIG. 3 is a schematic diagram illustrating the publishing of a host module on a system of interconnected processors;

FIG. 4 is a schematic diagram illustrating communications between a host module and a client module within a single thread;

FIG. 5 is a schematic diagram illustrating communications between a host module in one thread within a process and a client module in a different thread within the same process;

FIG. 6 is a schematic diagram illustrating communications between a host module in a thread within one process and a client module in a thread within a different process;

FIG. 7 is a schematic diagram illustrating communications between a host module in a thread within a process in one processor and a client module in a thread within the a process in a different processor;

FIG. 8 is a perspective view of a gaming machine in accordance with one or more embodiments;

FIGS. 9A and 9B are block diagrams of the physical and logical components of the gaming machine of FIG. 8 in accordance with one or more embodiments;

FIG. 10 is a block diagram of the logical components of a gaming kernel in accordance with one or more embodiments;

FIGS. 11A and 11B are schematic block diagrams showing the hardware elements of a networked gaming system in accordance with one or more embodiments;

FIG. 12 is a diagram showing an example of an architecture for tying a casino enterprise network to an external provider of games and content to Internet or broadband communication capable devices.

### DETAILED DESCRIPTION OF THE PREFERRED EMBODIMENTS

Terminology

Processor—hardware which can execute a sequence of executable instructions (termed an execution stream) to perform a task. The term processor includes a microprocessor, microcomputer, minicomputer, main frame computer, data processor, server, client, or other such term representing hardware that can execute execution streams A processor includes a central processing unit, memory for storing executable instructions and data, and input/output capabilities for receiving data from and sending data to outside sources. These outside sources may include input user devices, output user devices, circuitry for producing signals, circuitry for receiving signals, networks and mass storage devices. A processor also generally includes an operating system and utilities to control the execution of processes.

Process—A process is an execution stream associated with a block of memory and having a particular process state. The process state includes data which affects the results of executing the instructions (e.g. registers, stack, memory, files, signals, etc.). Processes do not share any of their state with other processes. More specifically, one process cannot access the memory of another process.

Thread—A thread is an execution stream having a particular thread state within a process. The thread state includes less information than a process state (e.g. registers, stack.) Threads may share parts of their thread states with other threads. For example, typically multiple threads within a process share process memory to read and write, and can, thereby, exchange information among them.

Module—A module is a set of executable statements which forms a self-contained unit. A module may be a routine, class, or other set of related executable statements. Modules may exist within processes or threads.

IPC—Inter-Process Communication—This form of communication is designed to transfer data between processes. The mechanism is also capable of transferring data from a process and back to the same process, possibly to a different thread or to the same thread.

IMC—Inter-Module Communication—This form of communication is designed to allow any module to communicate with another module. That other module may be within the same thread, a different thread or a different processor. IMC may utilize IPC when communicating with a module on another process or processor.

Host—This is the server side of a connection. The string “Host” is also the address of the server in any connection.

Listener Object—This is an object used for listening for and receiving incoming connections. This is used by the Host.

Connection Object—This is an object representing the local end of a connection. Both the server and the client side of the connection have the same data type.

Detailed Description

In the following detailed description of the invention, object oriented design techniques and terminology will be used to better express the complexities of multiple connections and interactions between modules. One skilled in the art of computer programming understands these techniques and terminology.

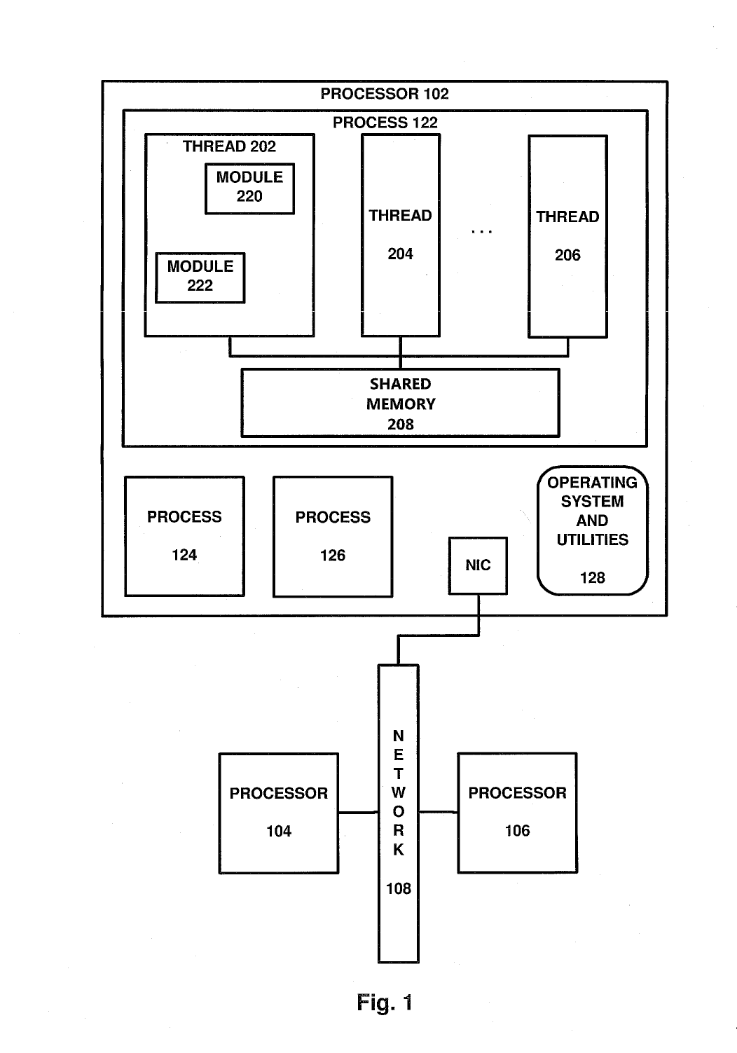

FIG. 1 is a schematic diagram illustrating the relationships among processors, processes within the processors, threads within the processes, and modules within threads. In FIG. 1, processors 102, 104, and 106 are similar, so only processor 102 is illustrated in detail in order to simplify the figure. One skilled in the art understands there may be any number of processors attached to the network 108.

Processors 102, 104 and 106 are coupled to a network 108 through a network interface circuit (NIC—shown cross hatched to indicate it is hardware and not executable instructions) in a known manner For example, the network 108 may include an Ethernet connection to couple the processors 102, 104 and 106 to the network 108, and data may be transferred through the network 108 using a TCP/IP protocol. The network 108 may include hubs, routers, switches, modems, bridges, concentrators, or other network equipment necessary to implement and maintain the network 108. In addition the network may include wired network links, wireless network links or both. In particular, the link between any processor (e.g. 102) and network 108 may be a wireless link.

Processor 102 is executing three processes, 122, 124 and 126. Processes 122, 124 and 126 are similar so only process 122 is illustrated in detail to simplify the figure. One skilled in the art understands that a processor (102) may include any number of processes. Within process 122, are a plurality of threads, including threads 202, 204 and 206. One skilled in the art understands that a process (122) may include any number of threads. The threads 202, 204, 206 share a memory 208 among them. All of them may read data from and write data to the shared memory 208.

Thread 202 includes modules 220 and 222. As described above, modules 220 and 222 are respective sets of executable instructions which form a self-contained unit. One skilled in the art understands that a thread may be a module, or may contain any number of modules.

In operation, as described above, a module (220, 222) in one process 122 may communicate with any other module (220, 222) in the process 122 using the shared memory 208, as described above. However, because different processes do not share a memory, a module (220, 222) in one process 122 may not communicate with a module in another process (124, 126) using the shared memory 208.

Inter-module communication according to the present invention operates across processes within a processor, within processes, and across modules in different processors. Inter-module communication must be able to cross the network due to the possible separation of one module and the other module across different processors, which are able to communicate only through the network.

In operation, the operating system 128 instantiates a process upon power-on and/or a request from a user and schedules execution of the process execution stream specified in the process. The operating system 128 also instantiates a thread on request from a process and schedules execution of the thread execution stream. The instantiated thread includes a thread manager. A thread manager is an object loaded in every module thread (excluding threads such as wait threads which depend on the external system or hardware). An instance of a thread manager is created by a module loader (not shown) for the process. The module loader sends commands to the thread manager to load modules in its thread, and the module loader will send commands to instantiate and control the initialization sequence of those modules.

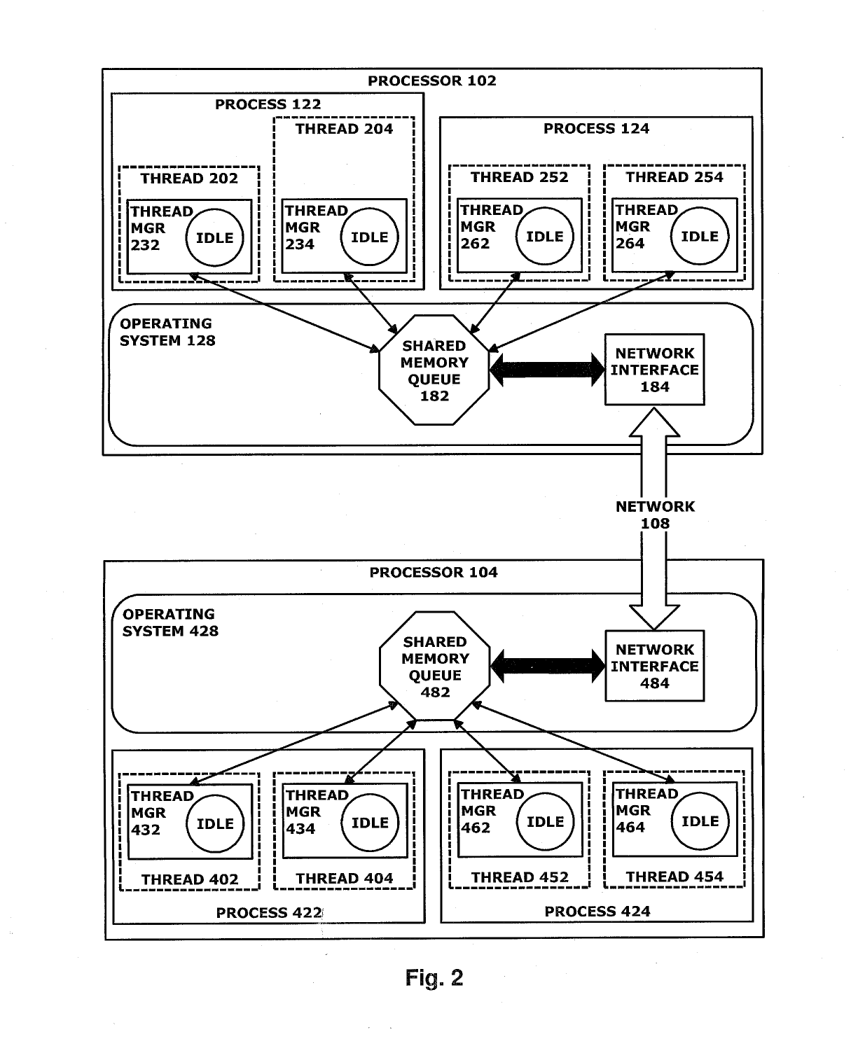

FIG. 2 is a schematic diagram of processors showing the interconnection of processes and threads for implementing an inter-process communication technique which is operable across processors. In FIG. 2, processors 102 and 104 are illustrated. Processor 102 includes processes 122 and 124; and processor 104 includes processes 422 and 424. Each process includes respective threads. Process 122 includes threads 202 and 204; process 124 includes threads 252 and 254; process 422 includes threads 402 and 404; and process 424 includes threads 452 and 454. Each thread includes a thread manager implementing an idle loop. Thread 202 includes a thread manager 232; thread 204 includes thread manager 234; thread 252 includes thread manager 262; thread manager 254 includes thread manager 264; thread 402 includes thread manager 432; thread 404 includes thread manager 434; thread 452 includes thread manager 462; and thread 454 includes thread manager 464.

In each processor 102, 104, the operating system 128, 428 contains a shared memory queue 182, 482, respectively, which is coupled to the respective thread managers. Shared memory queue 182 is coupled to thread managers 232, 234, 262, and 264 in processor 102; and shared memory queue 482 is coupled to thread managers 432, 434, 462 and 464. Each shared memory queue is coupled to a network interface or driver. Shared memory queue 182 is coupled to a network interface 184; and shared memory queue 482 is coupled to a network interface 484. Network interface 184 in processor 102 is coupled to network interface 484 in processor 104 via network 108.

In operation, the shared memory queue 182, 482 and the network 108 interoperate to communicate inter-processor messages from a thread in one processor to a thread possibly in a different processor. In such an arrangement a module in a thread in one processor operates as a host or server and a module in a thread in another processor operates as a client. In order to operate as a host, the thread must provide data to the appropriate executable programs in the operating system (128, 428) so that clients can find it when they attempt to connect. More specifically, for a thread to publish its existence as a host, it sends information identifying itself to the shared memory queue and network interface.

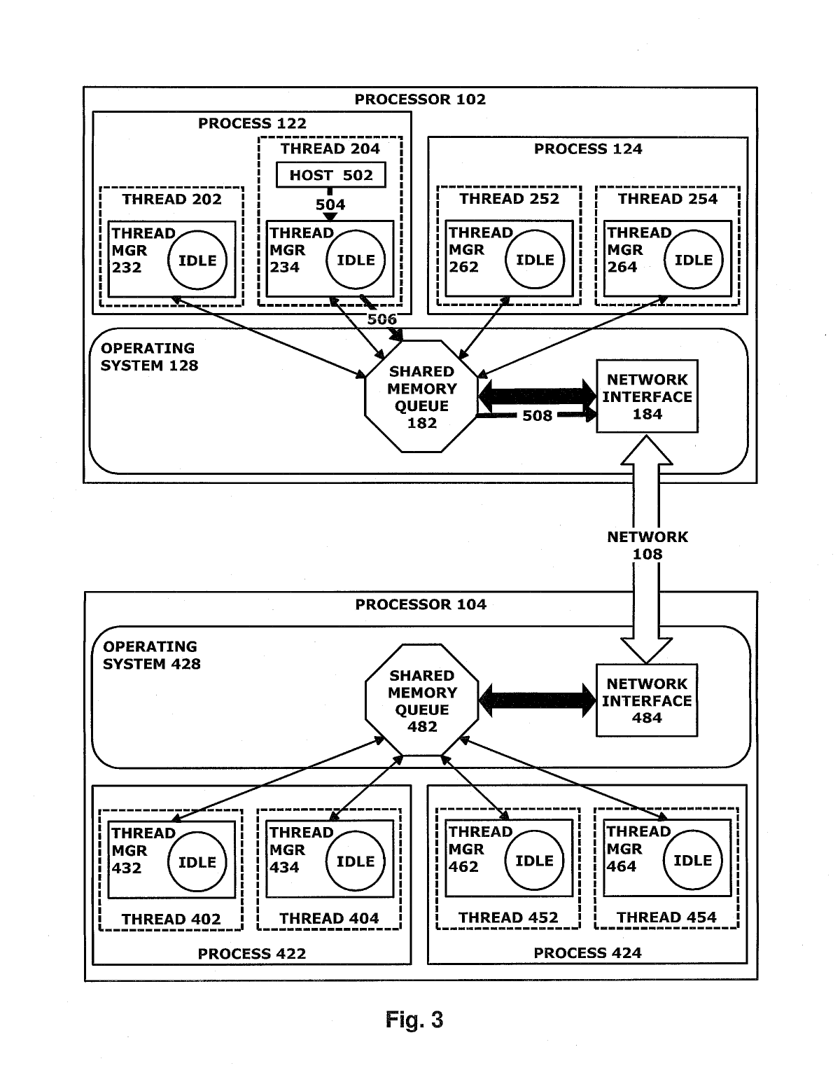

Referring now to FIG. 3, to operate as a host, a thread (e.g. 204) loads a host module 502. The host module 502 sends (504) information which may be used to identify the host module 502 to the thread manager 234. The thread manager 234 receives the host module identification information from the host module 502. The thread manager 234 adds information which may be used to identify the thread 204 and process 122 and forwards (506) the composite information to the shared memory queue 182. The shared memory queue (182, 482) stores that data and makes it available to other threads. Client modules in other threads (202, 252, 254) and other processes (124), trying to communicate with that host module 502 can check the information in the shared memory queue 182 to find out where the host module 502 is, and communicate with it.

When a client module wants to communicate with a host module, there are four possible situations. The host module being connected to might be: (1) in the same thread as the client module that is connecting; (2) in a different thread within the same process; (3) in a different process on the same processor, or (4) in a process on a different processor.

If a host module is in the same thread (case 1), or in the same process (case 2), or in a different process on the same processor (case 3), the client will establish a connection through the shared memory queue in that processor. This is similar to the shared memory communication technique of the prior art, except the operating system maintains a shared memory queue across all processes executing in the processor. If a connection via the shared memory queue cannot be established, e.g. because the host module is on a different processor than the client module (case 4), the client module will attempt to connect to the host module via the network interface.

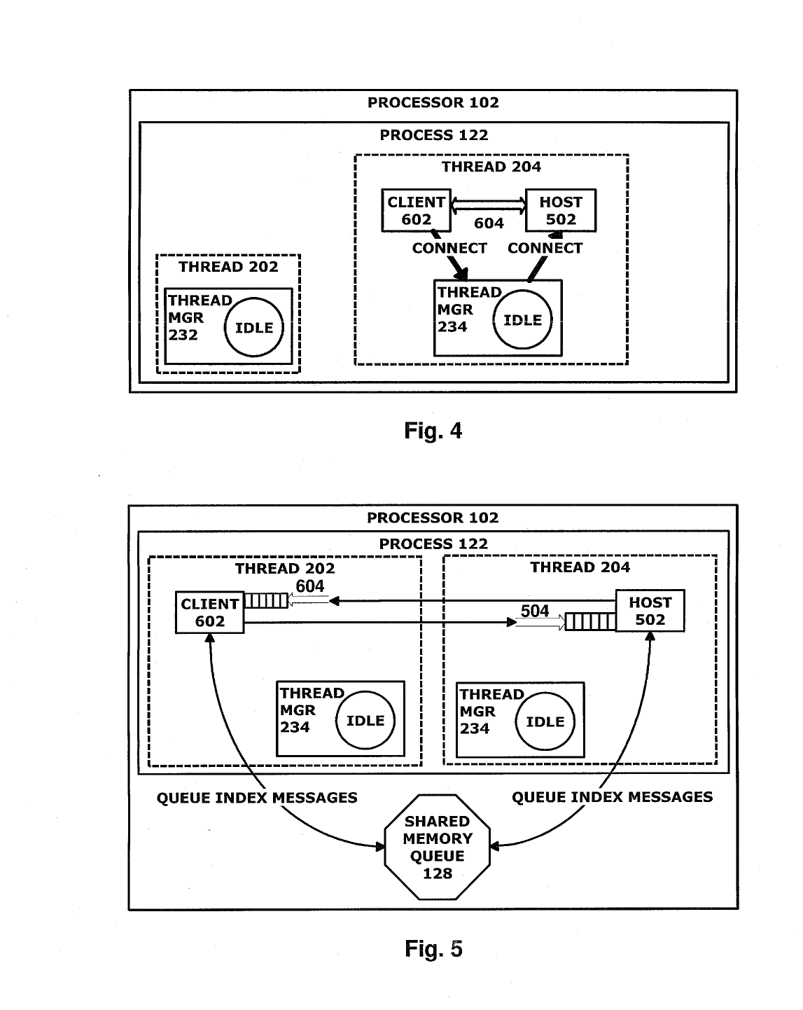

FIG. 4 illustrates the process of establishing communications between a client module 602 and a host module 502 in the same thread 204 in a process 122 in processor 102. In FIG. 4, client module 602 sends a message to the thread manager 234 asking for communication information for the previously registered host module 502 (as described above). The response to that message is the location of the host module 502. The thread manager 234 sends a message to the host 502 to inform it to expect a communication from the client module 602 and includes communication information for the client module 602. The client module 602 and host module 502 then can initiate direct communications 604.

FIG. 5 illustrates the process of establishing communications between a client module 602 in one thread 202 in a process 122 in a processor 102 and a host module 502 in a different thread 204 in the same process 122 in the same processor 102. Because they are in different threads, there is no guarantee that the two modules are operating in synchronism. Consequently, messages passed between the modules are queued for processing. In FIG. 5, client module 602 creates a queue 604 for receiving communications from the host module 502, then sends identification information to the shared memory queue 128 and requests a communication channel to the host module 502. The shared memory queue 128 responds with location information for the host module 502, then sends the identification information to the host module 502. The host module 502 prepares for communicating with the client module 602 by creating a queue 504 for receiving communications from the client module 602.

In operation, the client module 602 sends data to the queue 504 of the host module 502, and informs the shared memory queue 128. The host module 502 pops the message from the queue 504, and operates on it. In response the host module 502 sends data to the queue 604 of the client module 602, and informs the shared memory queue. The client module 602 pops the message from the queue 604 and operates on it. In this manner, communications is carried on between the client module 602 in one thread and the host module 502 in a different thread in the same process on the same processor.

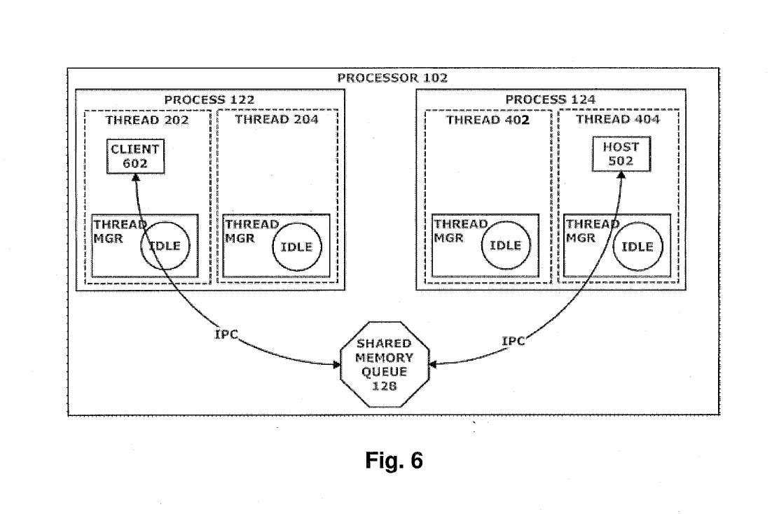

FIG. 6 is a schematic diagram which illustrates the process of establishing communications between a client module 602 in one thread 202 of one process 122 in a processor 102 and a host module 502 in a different thread 404 of a different process 124 in the same processor 102. The client module 602 provides an inter-process call (IPC) message to the shared memory queue. The message is stored in a predetermined location in the shared memory queue 128. The host module 502 contacts the shared memory queue 128 to retrieve the queued message from the client module 602. The host module 502 processes the retrieved message. In response, the host module 502 provides an inter-process call message to the shared memory queue 128. The message is stored in a predetermined location in the shared memory queue 128. The client module 602 contacts the shared memory queue 128 to retrieved the queued message from the host module 502. The client module 602 processes the retrieved message.

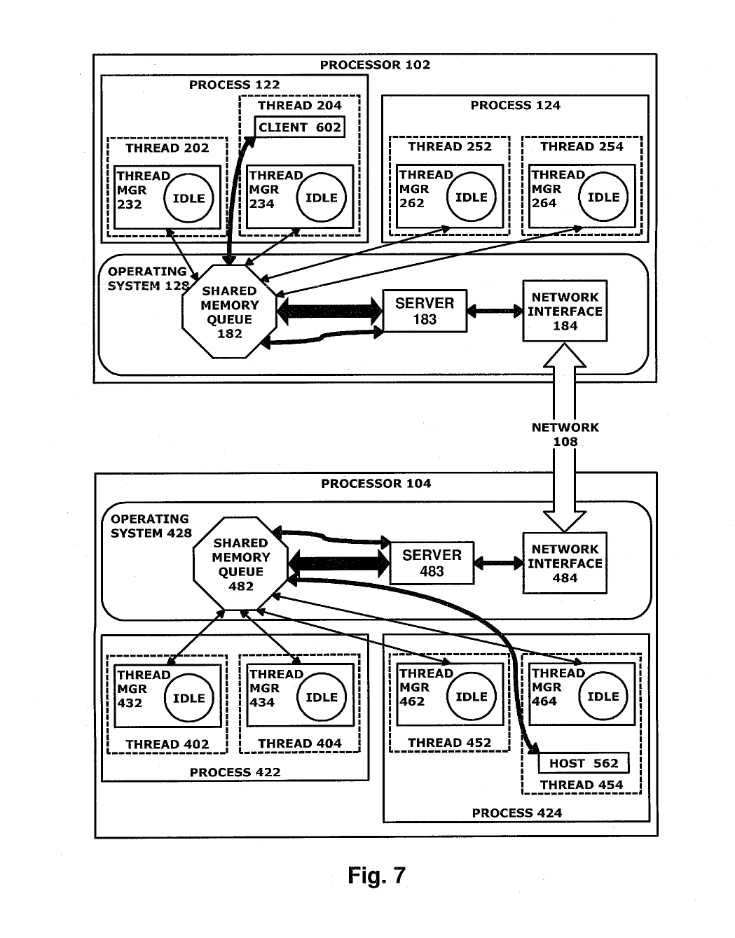

FIG. 7 is a schematic diagram of processors showing the interconnection of processes and threads for implementing an inter-process communication technique which is operable across processors. In FIG. 7, processors 102 and 104 are illustrated. Processor 102 includes processes 122 and 124; and processor 104 includes processes 422 and 424. Each process includes respective threads. Process 122 includes threads 202 and 204; process 124 includes threads 252 and 254; process 422 includes threads 402 and 404; and process 424 includes threads 452 and 454. Each thread includes a thread manager implementing an idle loop. Thread 202 includes a thread manager 232; thread 204 includes thread manager 234; thread 252 includes thread manager 262; thread manager 254 includes thread manager 264; thread 402 includes thread manager 432; thread 404 includes thread manager 434; thread 452 includes thread manager 462; and thread 454 includes thread manager 464.

Each processor 102, 104 include an operating system. Processor 102 includes operating system 128 and processor 104 includes operating system 428. In each processor 102, 104, the operating system 128, 428 contains a shared memory queue 182, 482, respectively, which is coupled to the respective thread managers. Shared memory queue 182 is coupled to thread managers 232, 234, 262, and 264 in processor 102; and shared memory queue 482 is coupled to thread managers 432, 434, 462 and 464. Each shared memory queue is coupled to a network interface or driver through a network server. Shared memory queue 182 is coupled to a network interface 184 through a network server 183; and shared memory queue 482 is coupled to a network interface 484 through a network server 483. Network interface 184 in processor 102 is coupled to network interface 484 in processor 104 via the network 108. One skilled in the art understands that other processors may similarly be coupled to the network via network interfaces.

In operation, the shared memory queue 182, 482 and the network 108 interoperate to communicate inter-processor messages from a module in one processor to a module in a different processor. In such a communication process a module in one processor operates as a host or server and a module in another processor operates as a client. In order to operate as a host, the host module 562 publishes data to the operating system (128, 428) so that client modules can find it when they attempt to connect (as described in detail above).

Referring to FIG. 7. in operation a client module 602 in thread 204 of process 122 in processor 102, is placed in communication with a host module 562 in thread 454 of process 424 in processor 104. As described above, host module 562 has previously registered its location and presence in the shared memory queue 482. The shared memory queue 482 notifies the server 483 of the newly registered host module 562. The server 483, in turn publishes the location of the newly registered host module 562 across the network 108 to servers in other processors across the network 108.

The client module 602 sends a message to the shared memory queue 182 including location information for the client module 602, and indicating an attempt to communicate with host module 562. The shared memory queue 182 searches its internal memory for information about the host module 562. Because host module 562 is not in processor 102, that information is not found. Shared memory queue, consequently sends a message to the server 183 searching for host module 562. As described above, location data for the host module 562 was previously published across the network 108, and server 183 is aware of host module 562 and its location. Data representing the location of the host module 562 is supplied to the shared memory queue 182, then a message indicating that the client module 602 desires to communicate with the host module 562 is sent from the server 183 to the server 483 via the network 108. The server 483 sends a message through the shared memory queue 482 to the host module 562 indicating that the client module 602 desires to communicate with the host module 562. A communication connection is thus formed between the client module 602 and the host module 562.

In operation, client module 602 sends a message meant for host module 562 to the shared memory 182. Shared memory 182 accesses the information previously stored relating to host module 562, and in response forwards that message to the host module 562 via the network interface 184, the network 108, the network interface 484 and shared memory queue 482. The host module 562 receives and processes that message. In response, the host module 562 sends a message meant for client module 602 to the shared memory queue 482. The shared memory queue forwards the message to the host module 602 through the network interface 482, the network 108, the network interface 184 and the shared memory queue 182. The client module 602 receives and processes the message.

The connections formed using the IPC as disclosed in the present invention may be either synchronous or asynchronous. All connections are set up by a call to a function for initiating the connection. In synchronous connections, the function does not return until a communications connection is established. If the connection cannot be established, then the function does not return, and the processor freezes.

In asynchronous connections, the function immediately returns while the connection process proceeds. A check must be performed by the program to determine if the connection process has succeeded, failed, or is still in process. This may be done in two ways. First, a function or method may be called which will return data representing the status of the connection. In one embodiment, the status representative data is a Boolean having the value true if the connection is complete, and false otherwise. Second, when the initial function call is made to establish a connection, a function may be passed to the connection function. When a connection is successfully completed, the passed function is called. This function responds to the successful establishment of a connection.

When making a connection, as described above, data representing a version is included with every message. Version representative data may be ignored. However, this data provides a developer an opportunity to provide and handle new functionality while still retaining the ability to provide and handle the functionality for previous versions.

Environment

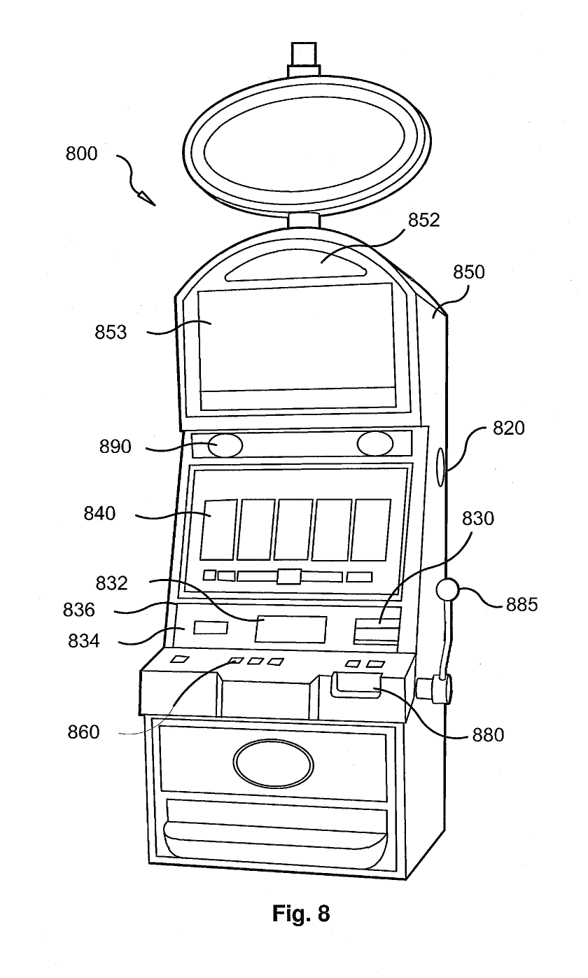

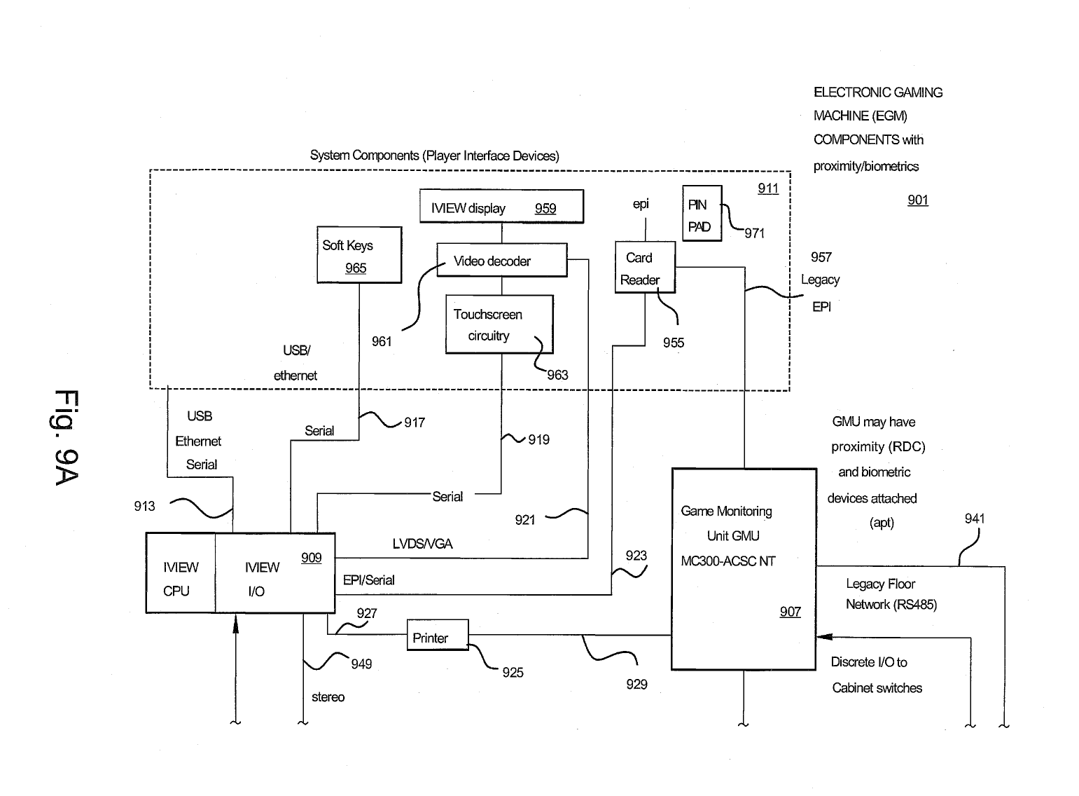

Referring to FIG. 8, gaming machine 800 capable of supporting various embodiments of the invention is shown, including cabinet housing 820, primary game display 840 upon which a primary game and feature game may be displayed, top box 850 which may display multiple progressives that may be won during play of the feature game, player-activated buttons 860, player tracking panel 836, bill/voucher acceptor 880 and one or more speakers 890. Cabinet housing 820 may be a self-standing unit that is generally rectangular in shape and may be manufactured with reinforced steel or other rigid materials which are resistant to tampering and vandalism. Cabinet housing 820 may alternatively be a handheld device including the gaming functionality as discussed herein and including various of the described components herein. For example, a handheld device may be a cell phone, personal data assistant, or laptop or tablet computer, each of which may include a display, a processor, and memory sufficient to support either stand-alone capability such as gaming machine 800 or thin client capability such as that incorporating some of the capability of a remote server. As another example, the cabinet housing 820 may be a personal computer, in any configuration such as a laptop or desktop or tower configuration. Such a personal computer includes a keyboard, mouse or touchpad or trackball, one or more display monitors, one or more processors, and memory sufficient to support the stand-alone capability of a gaming machine or of a thin client.

In one or more embodiments, cabinet housing 820 houses a processor, circuitry, and software (not shown) for receiving signals from the player-activated buttons 860, operating the games, and transmitting signals to the respective displays and speakers. Any shaped cabinet may be implemented with any embodiment of gaming machine 800 so long as it provides access to a player for playing a game. For example, cabinet 820 may comprise a slant-top, bar-top, or table-top style cabinet, including a Bally Cinevision™ or CineReels™ cabinet. The operation of gaming machine 800 is described more fully below.

The plurality of player-activated buttons 860 may be used for various functions such as, but not limited to, selecting a wager denomination, selecting a game to be played, selecting a wager amount per game, initiating a game, or cashing out money from gaming machine 800. Buttons 860 may be operable as input mechanisms and may include mechanical buttons, electromechanical buttons or touch screen buttons. Optionally, a handle 885 may be rotated by a player to initiate a game.

In one or more embodiments, buttons 860 may be replaced with various other input mechanisms known in the art such as, but not limited to, a touch screen system, touch pad, track ball, mouse, switches, toggle switches, or other input means used to accept player input such as a Bally iDeck™. One other example input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 820 may optionally include top box 850 which contains “top glass” 852 comprising advertising or payout information related to the game or games available on gaming machine 800. Player tracking panel 836 includes player tracking card reader 834 and player tracking display 832. Voucher printer 830 may be integrated into player tracking panel 836 or installed elsewhere in cabinet housing 820 or top box 850.

Game display 840 may present a game of chance wherein a player receives one or more outcomes from a set of potential outcomes. For example, one such game of chance is a video slot machine game. In other aspects of the invention, gaming machine 800 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 840 is, typically, a CRT or a flat-panel display in the form of, but not limited to, liquid crystal, plasma, electroluminescent, vacuum fluorescent, field emission, or any other type of panel display known or developed in the art. Game display 840 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 840 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference in its entirety for all purposes.

Game display 840 may also present information such as, but not limited to, player information, advertisements and casino promotions, graphic displays, news and sports updates, or even offer an alternate game. This information may be generated through a host computer networked with gaming machine 800 on its own initiative or it may be obtained by request of the player using either one or more of the plurality of player-activated buttons 860; the game display itself if game display 840 comprises a touch screen or similar technology; buttons (not shown) mounted about game display 840 which may permit selections such as those found on an ATM machine, where legends on the screen are associated with respective selecting buttons; or any player input device that offers the required functionality.

Cabinet housing 820 incorporates a single game display 840. However, in alternate embodiments, cabinet housing 820 or top box 850 may house one or more additional displays 853 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

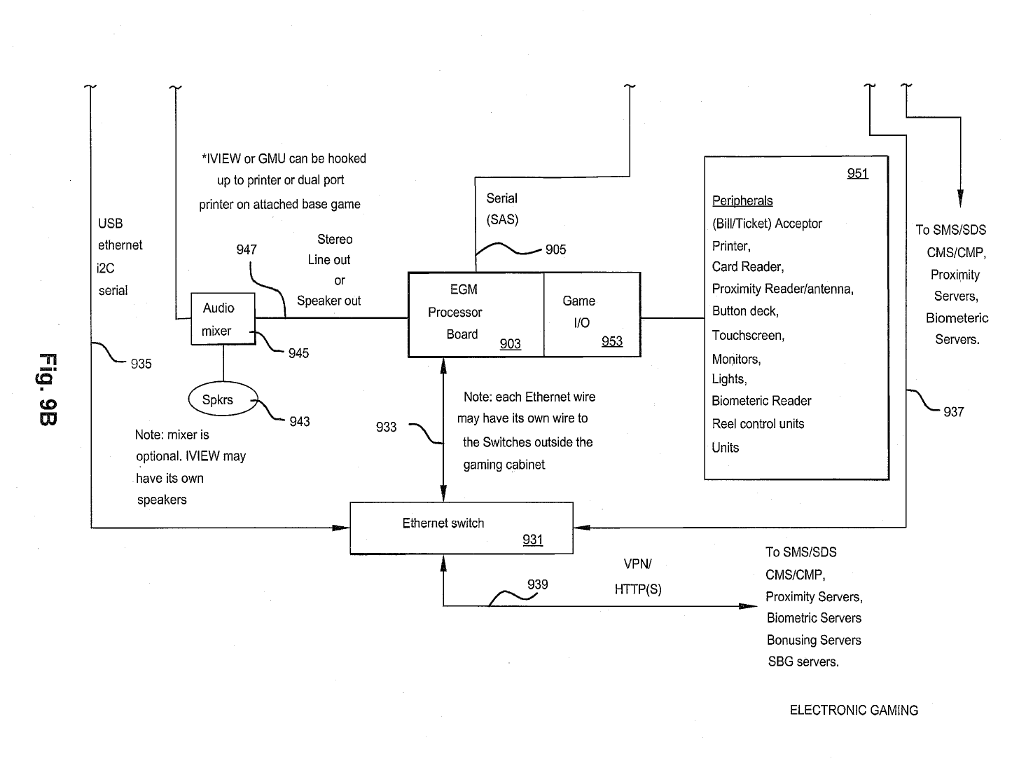

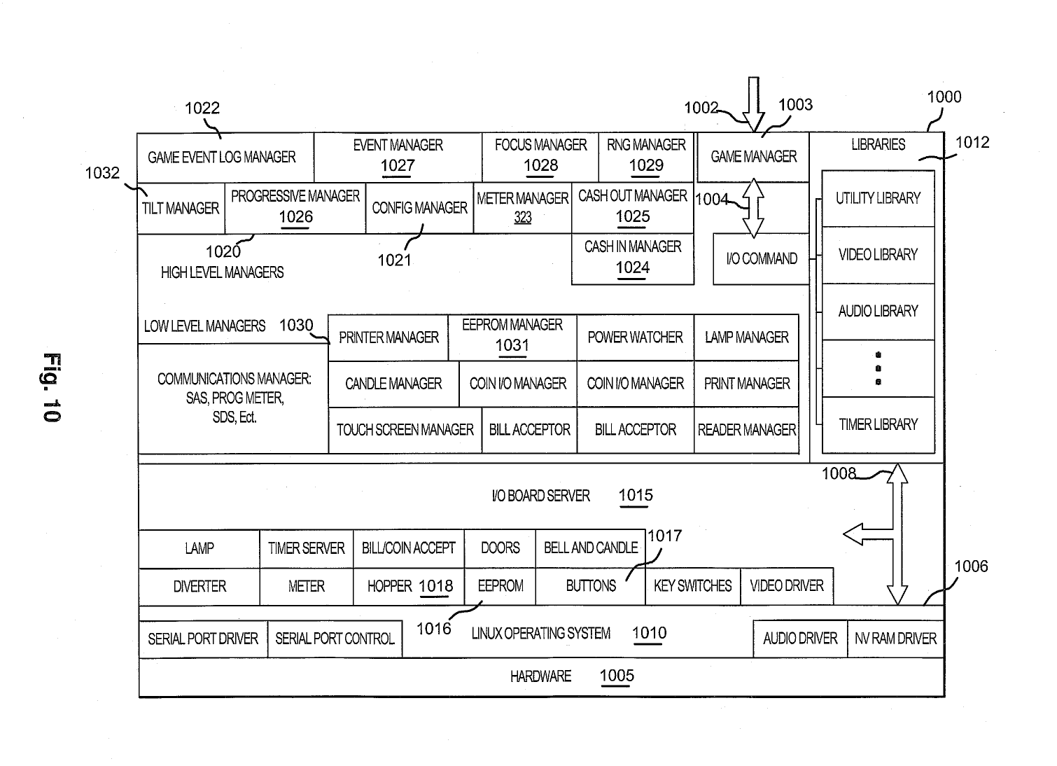

Referring to FIG. 9 Error! Reference source not found., electronic gaming machine 901 is shown in accordance with one or more embodiments. Electronic gaming machine 901 includes base game integrated circuit board 903 (EGM Processor Board) connected through serial bus line 905 to game monitoring unit (GMU) 907 (such as a Bally MC300 or ACSC NT), and player interface integrated circuit board (PIB) 909 connected to player interface devices 911 over bus lines 913, 917, 919, 921 and 923, respectively. Printer 925 is connected to PIB 909 and GMU 907 over bus lines 927 and 929, respectively. Base game integrated circuit board 903, PIB 909, and GMU 907 connect to Ethernet switch 931 over bus lines 933, 935 and 937, respectively. Ethernet switch 931 connects to a slot management system (SMS) and a casino management system (CMS) network over bus line 939. GMU 907 also may connect to the SMS and CMS network over bus line 941. Speakers 943 connect through audio mixer 945 and bus lines 947 and 949 to base game integrated circuit board 903 and PIB 909, respectively. Proximity and biometric devices and circuitry may be installed by upgrading a commercially available PIB 909, such as a Bally iView unit. Coding executed on base game integrated circuit board 903, PIB 909, and/or GMU 907 may be upgraded to integrate a game having adjustable multi-part indicia as is more fully described herein.

Peripherals 951 connect through I/O board 953 to base game integrated circuit board 903. For example, a bill/ticket acceptor is typically connected to a game input-output board 953 which is, in turn, connected to a conventional central processing unit (“CPU”) base game integrated circuit board 903, such as an Intel Pentium microprocessor mounted on a gaming motherboard. The I/O board 953 may be connected to base game integrated circuit board 903 by a serial connection such as RS-232 or USB or may be attached to the processor by a bus such as, but not limited to, an ISA bus, or by direct connections to the base game integrated circuit board 903 as a daughter board. The gaming motherboard may be mounted with other conventional components, such as are found on conventional personal computer motherboards, and loaded with a game program which may include a gaming machine operating system (OS), such as a Bally Alpha OS. Base game integrated circuit board 903 executes a game program that causes base game integrated circuit board 903 to play a game. In one embodiment, the game program provides a slot machine game having adjustable multi-part indicia. The various components and included devices may be installed with conventionally and/or commercially available components, devices, and circuitry into a conventional and/or commercially available gaming machine cabinet, examples of which are described above.

When a player has inserted a form of currency such as, for example and without limitation, paper currency, coins or tokens, cashless tickets or vouchers, electronic funds transfers or the like into the currency acceptor, a signal is sent by way of I/O board 953 to base game integrated circuit board 903 which, in turn, assigns an appropriate number of credits for play in accordance with the game program. The player may further control the operation of the gaming machine by way of other peripherals 951, for example, to select the amount to wager via electromechanical or touch screen buttons. The game starts in response to the player operating a start mechanism such as a handle or touch screen icon. The game program includes a random number generator to provide a display of randomly selected indicia on one or more displays. In some embodiments, the random generator may be physically separate from gaming machine 900; for example, it may be part of a central determination host system which provides random game outcomes to the game program. Thereafter, the player may or may not interact with the game through electromechanical or touch screen buttons to change the displayed indicia. Finally, base game integrated circuit board 903 under control of the game program and OS compares the final display of indicia to a pay table. The set of possible game outcomes may include a subset of outcomes related to the triggering of a feature game. In the event the displayed outcome is a member of this subset, base game integrated circuit board 903, under control of the game program and by way of I/O Board 953, may cause feature game play to be presented on a feature display.

Predetermined payout amounts for certain outcomes, including feature game outcomes, are stored as part of the game program. Such payout amounts are, in response to instructions from base game integrated circuit board 903, provided to the player in the form of coins, credits or currency via I/O board 953 and a pay mechanism, which may be one or more of a credit meter, a coin hopper, a voucher printer, an electronic funds transfer protocol or any other payout means known or developed in the art.

In various embodiments, the game program is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a wide area network (possibly including the Internet), a TCP/IP connection, a wireless connection, or any other means for operatively networking components together. Optionally, other data including graphics, sound files and other media data for use with the EGM are stored in the same or a separate memory device (not shown). Some or all of the game program and its associated data may be loaded from one memory device into another, for example, from flash memory to read/write (random access) memory (RAM).

In one or more embodiments, peripherals may be connected to the system over Ethernet connections directly to the appropriate server or tied to the system controller inside the EGM using USB, serial or Ethernet connections. Each of the respective devices may have upgrades to their firmware utilizing these connections.

GMU 907 includes an integrated circuit board and GMU processor and memory including coding for network communications, such as the G2S (game-to-system) protocol promulgated by Gaming Standards Association, Las Vegas, Nev., used for system communications over the network. As shown, GMU 907 may connect to card reader 955 through bus 957 and may thereby obtain player card information and transmit the information over the network through bus 941. Gaming activity information may be transferred by the base game integrated circuit board 903 to GMU 907 where the information may be translated into a network protocol, such as S2S, for transmission to a server, such as a player tracking server, where information about a player's playing activity may be stored in a designated server database.

PIB 909 includes an integrated circuit board, PID processor, and memory which includes an operating system, such as Windows CE, a player interface program which may be executable by the PID processor and various input/output (I/O) drivers for respective devices which connect to PIB 909. These devices include player interface devices 911. The PIB 909 may further include various games or game components playable on PIB 909 or playable on a connected network server for which PIB 909 is operable as the player interface. PIB 909 connects to card reader 955 through bus 923, display 959 through video decoder 961 and bus 921, such as an LVDS or VGA bus.

As part of its programming, the PID processor executes coding to drive display 959 to provide messages and information to a player. Touch screen circuitry 963 interactively couples display 959 and video decoder 961 to PIB 909, such that a player may input information and cause the information to be transmitted to PIB 909 via the touch screen 963 either on the player's initiative or responsive to a query by PIB 909. Additionally soft keys 965 connect through bus 917 to PIB 909 and operate together with display 959 to provide information or queries to a player and receive responses or queries from the player. PIB 909, in turn, communicates over the CMS/SMS network through Ethernet switch 931 and busses 935, 939 and with respective servers, such as a player tracking server.

Player interface devices 911 are linked into the virtual private network of the system components in gaming machine 901. The system components include the iView processing board and game monitoring unit (GMU) processing board. These system components may connect over a network to the slot management system (such as a commercially available Bally SDS/SMS) and/or casino management system (such as a commercially available Bally CMP/CMS).

The GMU system component has a connection to the base game through a serial SAS connection 905 and is connected to various servers using, for example, HTTPs over Ethernet. Through this connection, firmware, media, operating system software, gaming machine configurations can be downloaded to the system components from the servers. This data is authenticated prior to install on the system components.

The system components include the iView processing board and game monitoring unit (GMU) processing board. The GMU and iView can combined into one like the commercially available Bally GTM iView device. This device may have a video mixing technology to mix the EGM processor's video signals with the iView display onto the top box monitor or any monitor on the gaming device.

In accordance with one or more embodiments, FIG. 10 Error! Reference source not found. is a functional block diagram of a gaming kernel 1000 of a game program under control of base game integrated circuit board 903 (FIG. 9). The game program uses gaming kernel 1000 by calling into application programming interface (API) 1002, which is part of game manager 1003. The components of game kernel 1000 as shown in FIG. 10 are only illustrative, and should not be considered limiting. For example, the number of managers may be changed, additional managers may be added or some managers may be removed without deviating from the scope and spirit of the invention.

As shown in the example, there are three layers: a hardware layer 1005; an operating system layer 1010, such as, but not limited to, Linux; and a game kernel layer 1000 having game manager 1003 therein. In one or more embodiments, the use of a standard operating system 1010, such a UNIX-based or Windows-based operating system, allows game developers interfacing to the gaming kernel to use any of a number of standard development tools and environments available for the operating systems. This is in contrast to the use of proprietary, low level interfaces which may require significant time and engineering investments for each game upgrade, hardware upgrade, or feature upgrade. The game kernel layer 1000 executes at the user level of the operating system 1010, and itself contains a major component called the I/O Board Server 1015. To properly set the bounds of game application software (making integrity checking easier), all game applications interact with gaming kernel 1000 using a single API 1002 in game manager 1003. This enables game applications to make use of a well-defined, consistent interface, as well as making access points to gaming kernel 1000 controlled, where overall access is controlled using separate processes.

For example, game manager 1003 parses an incoming command stream and, when a command dealing with I/O comes in (arrow 1004), the command is sent to an applicable library routine 1012. Library routine 1012 decides what it needs from a device, and sends commands to I/O Board Server 1015 (see arrow 1008). A few specific drivers remain in operating system 1010's kernel, shown as those below line 1006. These are built-in, primitive, or privileged drivers that are (i) general (ii) kept to a minimum and (iii) are easier to leave than extract. In such cases, the low-level communications is handled within operating system 1010 and the contents passed to library routines 1012.

Thus, in a few cases library routines may interact with drivers inside operating system 1010, which is why arrow 1008 is shown as having three directions (between library utilities 1012 and I/O Board Server 1015, or between library utilities 1012 and certain drivers in operating system 1010). No matter which path is taken, the logic needed to work with each device is coded into modules in the user layer of the diagram. Operating system 1010 is kept as simple, stripped down, and common across as many hardware platforms as possible. The library utilities and user-level drivers change as dictated by the game cabinet or game machine in which it will run. Thus, each game cabinet or game machine may have a base game integrated circuit board 903 (FIG. 9) connected to a unique, relatively dumb, and as inexpensive as possible I/O adapter board 940, plus a gaming kernel 1000 which will have the game-machine-unique library routines and I/O Board Server 1015 components needed to enable game applications to interact with the gaming machine cabinet. Note that these differences are invisible to the game application software with the exception of certain functional differences (i.e., if a gaming cabinet has stereo sound, the game application will be able make use of API 1002 to use the capability over that of a cabinet having traditional monaural sound).

Game manager 1003 provides an interface into game kernel 1000, providing consistent, predictable, and backwards compatible calling methods, syntax, and capabilities by way of game application API 1002. This enables the game developer to be free of dealing directly with the hardware, including the freedom to not have to deal with low-level drivers as well as the freedom to not have to program lower level managers 1030. The lower level managers 1030 may be accessed through game manager 1003′s interface 1002 if a programmer has the need. In addition to the freedom derived from not having to deal with the hardware level drivers and the freedom of having consistent, callable, object-oriented interfaces to software managers of those components (drivers), game manager 1003 provides access to a set of high level managers 1020 also having the advantages of consistent callable, object-oriented interfaces, and further providing the types and kinds of base functionality required in casino-type games. Game manager 1003, providing all the advantages of its consistent and richly functional interface 1002 as supported by the rest of game kernel 1000, thus provides a game developer with a multitude of advantages.

Game manager 1003 may have several objects within itself, including an initialization object (not shown). The initialization object performs the initialization of the entire game machine, including other objects, after game manager 1003 has started its internal objects and servers in appropriate order. In order to carry out this function, the kernel's configuration manager 1021 is among the first objects to be started; configuration manager 1021 has data needed to initialize and correctly configure other objects or servers.

The upper level managers 1020 of game kernel 1000 may include game event log manager 1022 which provides, at the least, a logging or logger base class, enabling other logging objects to be derived from this base object. The logger object is a generic logger; that is, it is not aware of the contents of logged messages and events. The log manager's (1022) job is to log events in non-volatile event log space. The size of the space may be fixed, although the size of the logged event is typically not. When the event space or log space fills up, one embodiment will delete the oldest logged event (each logged event will have a time/date stamp, as well as other needed information such as length), providing space to record the new event. In this embodiment, the most recent events will thus be found in the log space, regardless of their relative importance. Further provided is the capability to read the stored logs for event review.

In accordance with one embodiment, meter manager 1023 manages the various meters embodied in the game kernel 1000. This includes the accounting information for the game machine and game play. There are hard meters (counters) and soft meters; the soft meters may be stored in non-volatile storage such as non-volatile battery-backed RAM to prevent loss. Further, a backup copy of the soft meters may be stored in a separate non-volatile storage such as EEPROM. In one embodiment, meter manager 1023 receives its initialization data for the meters, during start-up, from configuration manager 1021. While running, the cash in (1024) and cash out (1025) managers call the meter manager's (1023) update functions to update the meters. Meter manager 1023 will, on occasion, create backup copies of the soft meters by storing the soft meters' readings in EEPROM. This is accomplished by calling and using the low level 1030 EEPROM manager 1031.

In accordance with still other embodiments, progressive manager 1026 manages progressive games playable from the game machine. Event manager 1027 is generic, like log manager 1022, and is used to manage various gaming machine events. Focus manager 1028 correlates which process has control of various focus items. Tilt manager 1032 is an object that receives a list of errors (if any) from configuration manager 1021 at initialization, and during game play from processes, managers, drivers, etc. that may generate errors. Random number generator manager 1029 is provided to allow easy programming access to a random number generator (RNG), as a RNG is required in virtually all casino-style (gambling) games. RNG manager 1029 includes the capability of using multiple seeds.

In accordance with one or more embodiments, a credit manager object (not shown) manages the current state of credits (cash value or cash equivalent) in the game machine, including any available winnings, and further provides denomination conversion services. Cash out manager 1025 has the responsibility of configuring and managing monetary output devices. During initialization, cash out manager 1025, using data from configuration manager 1021, sets the cash out devices correctly and selects any selectable cash out denominations. During play, a game application may post a cash out event through the event manager 1027 (the same way all events are handled), and using a call-back posted by cash out manager 1025, cash out manager 1025 is informed of the event. Cash out manager 1025 updates the credit object, updates its state in non-volatile memory, and sends an appropriate control message to the device manager that corresponds to the dispensing device. As the device dispenses dispensable media, there will typically be event messages being sent back and forth between the device and cash out manager 1025 until the dispensing finishes, after which cash out manager 1025, having updated the credit manager and any other game state (such as some associated with meter manager 1023) that needs to be updated for this set of actions, sends a cash out completion event to event manager 1027 and to the game application thereby. Cash in manager 1024 functions similarly to cash out manager 1025, only controlling, interfacing with, and taking care of actions associated with cashing in events, cash in devices, and associated meters and crediting.

In a further example, in accordance with one or more embodiments, I/O server 1015 may write data to the gaming machine EEPROM memory, which is located in the gaming machine cabinet and holds meter storage that must be kept even in the event of power failure. Game manager 1003 calls the I/O library functions to write data to the EEPROM. The I/O server 1015 receives the request and starts a low priority EEPROM thread 1016 within I/O server 1015 to write the data. This thread uses a sequence of 8 bit command and data writes to the EEPROM device to write the appropriate data in the proper location within the device. Any errors detected will be sent as IPC messages to game manager 1003. All of this processing is asynchronous.

In accordance with one embodiment, button module 1017 within I/O server 1015, polls (or is sent) the state of buttons every 2 ms. These inputs are debounced by keeping a history of input samples. Certain sequences of samples are required to detect a button was pressed, in which case the I/O server 1015 sends an inter-process communication (IPC) event to game manager 1003 that a button was pressed or released. In some embodiments, the gaming machine may have intelligent distributed I/O which debounces the buttons, in which case button module 1017 may be able to communicate with the remote intelligent button processor to get the button events and simply relay them to game manager 1003 via IPC messages. In still another embodiment, the I/O library may be used for pay out requests from the game application. For example, hopper module 1018 must start the hopper motor, constantly monitor the coin sensing lines of the hopper, debounce them, and send an IPC message to the game manager 1003 when each coin is paid.

Further details, including disclosure of lower level fault handling and/or processing, are included in U.S. Pat. No. 7,351,151 entitled “Gaming Board Set and Gaming Kernel for Game Cabinets” and provisional U.S. patent application No. 60/313,743, entitled “Form Fitting Upgrade Board Set For Existing Game Cabinets,” filed Aug. 20, 2001; said patent and provisional are both fully incorporated herein by explicit reference.

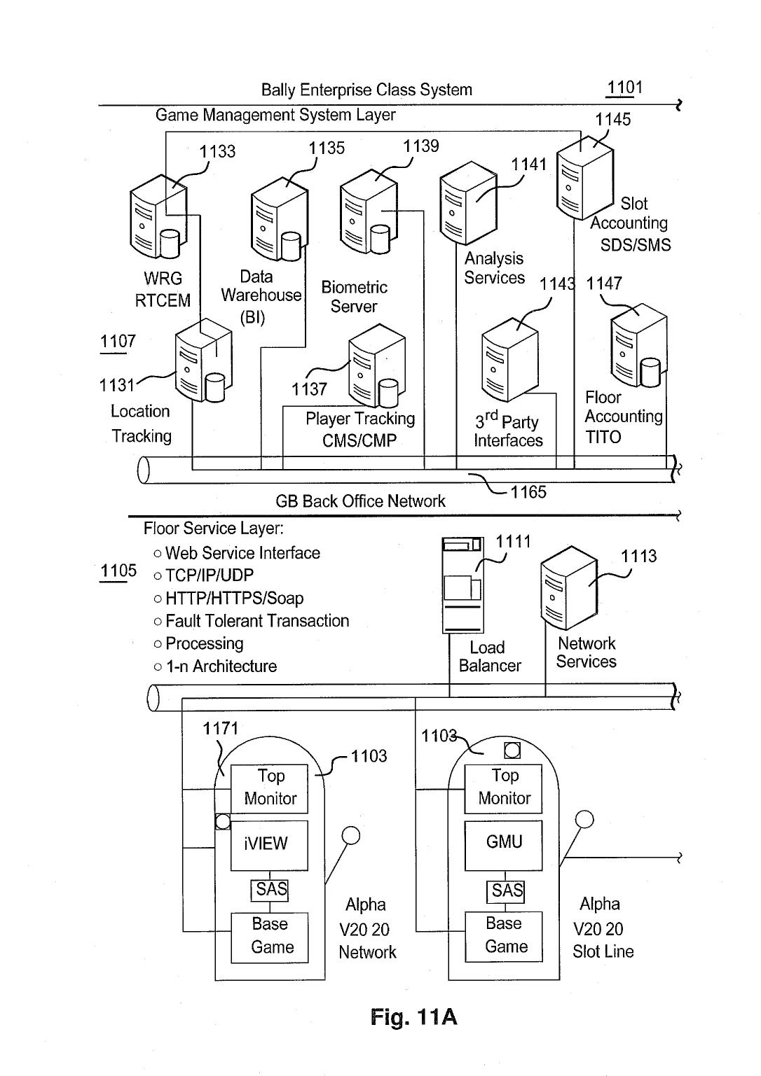

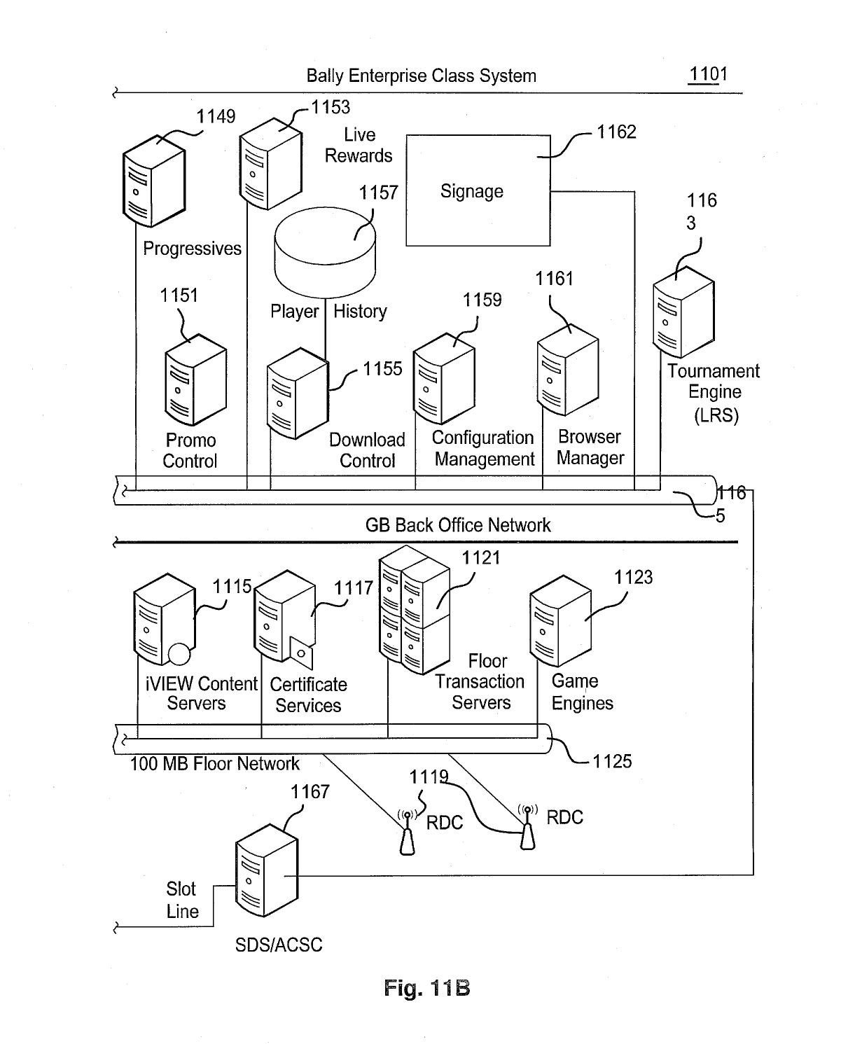

Referring to FIG. 11, enterprise gaming system 1101 is shown in accordance with one or more embodiments. Enterprise gaming system 1101 may include one casino or multiple locations and generally includes a network of gaming machines 1103, floor management system (SMS) 1105, and casino management system (CMS) 1107. SMS 1105 may include load balancer 1111, network services servers 1113, player interface (iView) content servers 1115, certificate services server 1117, floor radio dispatch receiver/transmitters (RDC) 1119, floor transaction servers 1121 and game engines 1123, each of which may connect over network bus 1125 to gaming machines 1103.

CMS 1107 may include location tracking server 1131, WRG RTCEM server 1133, data warehouse server 1135, player tracking server 1137, biometric server 1139, analysis services server 1141, third party interface server 1143, slot accounting server 1145, floor accounting server 1147, progressives server 1149, promo control server 1151, feature game (such as Bally Live Rewards) server 1153, download control server 1155, player history database 1157, configuration management server 1159, browser manager 1161, tournament engine server 1163 connecting through bus 1165 to server host 1167 and gaming machines 1103.

The various servers and gaming machines 1103 may connect to the network (1125, 1165) with various conventional network connections (such as, for example, USB, serial, parallel, RS485, Ethernet). Additional servers which may be incorporated with CMS 1107 include a responsible gaming limit server (not shown), advertisement server (not shown), and a control station server (not shown) where an operator or authorized personnel may select options and input new programming to adjust each of the respective servers and gaming machines 1103. SMS 1105 may also have additional servers including a control station (not shown) through which authorized personnel may select options, modify programming, and obtain reports of the connected servers and devices, and obtain reports. The various CMS and SMS servers are descriptively entitled to reflect the functional executable programming stored thereon and the nature of databases maintained and utilized in performing their respective functions.

Gaming machines 1103 include various peripheral components that may be connected with USB, serial, parallel, RS-485 or Ethernet devices/architectures to the system components within the respective gaming machine. The GMU has a connection to the base game through a serial SAS connection. The system components in the gaming cabinet may be connected to the servers using HTTPs or G2S over Ethernet. Using CMS 1107 and/or SMS 1105 servers and devices, firmware, media, operating systems, and configurations may be downloaded to the system components of respective gaming machines for upgrading or managing floor content and offerings in accordance with operator selections or automatically depending upon CMS 1107 and SMS 1105 master programming The data and programming updates to gaming machines 1103 are authenticated using conventional techniques prior to install on the system components.

In various embodiments, any of the gaming machines 1103 may be a mechanical reel spinning slot machine or a video slot machine or a gaming machine offering one or more of the above described games including a group play game. Alternately, gaming machines 1103 may provide a game with a simulated musical instrument interface as a primary or base game or as one of a set of multiple primary games selected for play by a random number generator. A gaming system of the type described above also allows a plurality of games in accordance with the various embodiments of the invention to be linked under the control of a group game server (not shown) for cooperative or competitive play in a particular area, carousel, casino or between casinos located in geographically separate areas. For example, one or more examples of group games under control of a group game server are disclosed in U.S. application Ser. No. 11/938,079, entitled “Networked System and Method for Group Play Gaming,” filed on Nov. 9, 2007, which is hereby incorporated by reference in its entirety for all purposes.

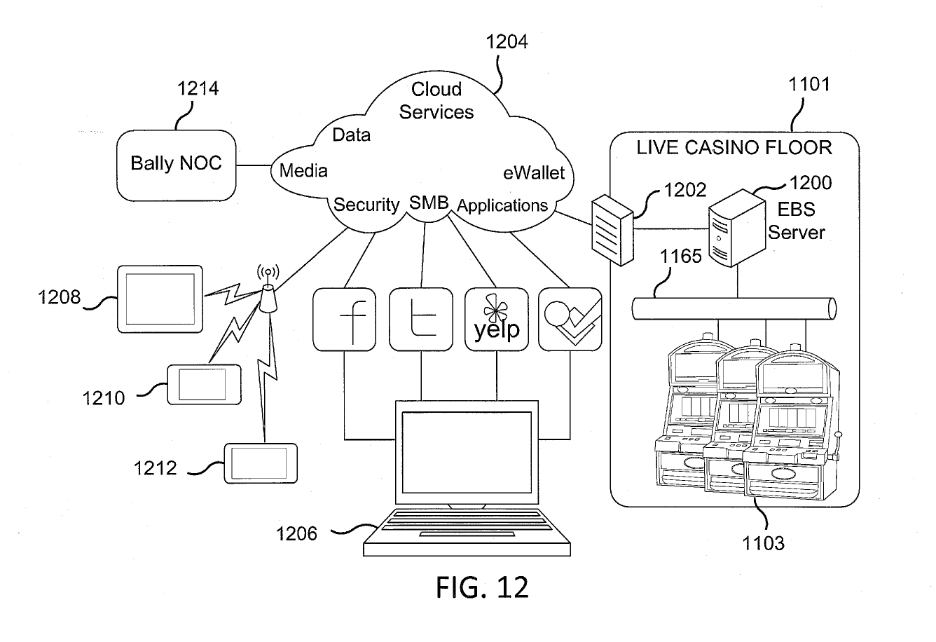

All or portions of the present invention may also be implemented by or promoted through a system as suggested in FIG. 12. The gaming system 1101 (illustrated in detail in FIG. 11), may be hosted at a casino property enterprise, across several casino enterprises or by a third party host. As described above, the gaming system 1101 has a network communication bus 1165 providing communication between the gaming terminals 1103 and various servers. To provide the functionality illustrated in FIG. 12, a bonusing server 1200, such as a Bally Elite Bonusing Server is connected to the network communication bus 1165 for communication to the gaming system 1101, the gaming terminals 1103 and the various servers and other devices as described above. The bonusing server 1200 is in communication with a cloud computing/storage service 1204 through a secure network firewall 1202. The cloud computing/storage service 1204 may be hosted by the casino enterprise, a licensed third party or if permitted by gaming regulators an unlicensed provider. For example the cloud service 1204 may be as provided by Microsoft® Private Cloud Solutions offered by Microsoft Corp. of Redmond, Wash., USA. The cloud service 1204 provides various applications which can be accessed by and delivered to, for example, personal computers 1206, portable computing devices such as computer tablets 1208, personal digital assistants (PDAs) 1210 and cellular devices 1212 such as telephones and smart phones. As an example, the cloud service 1204 may store and host: (a) an eWallet application, (b) a casino or player-centric applications such as downloadable or accessible applications including games, promotional material or applications directed to and/or affecting a casino customers interaction with a casino enterprise (such as accessing the players casino account, establishing casino credit or the like), (c) providing bonuses to players through system wide bonusing (SMB) or specific bonusing or comps to players, or (d) other applications. The cloud service 1204 includes security to provide for secure communication within the cloud service 1204, between the player/users and the cloud service 1204, and between the cloud service 1204 and the gaming system 1101. Security applications may be through encryption, the use of personal identification numbers (PINS) or other devices and systems. As suggested in FIG. 12, the cloud service 1204 stores player/user data retrieved from players/users and from the gaming system 1101.

The players/users may access the cloud service 1204 and the applications and data provided thereby through the Internet or through broadband wireless cellular communication systems and any intervening short range wireless communication such as Bluetooth® (a registered trademark of Bluetooth SIG, Inc.) or WiFi. The players/users may further access the applications and data through various social media offerings such as Facebook, Twitter, Yelp, MySpace, LinkedIn or the like.

As but an example, a player/user may have a player account with a casino enterprise Z. That account may include data such as the player's credit level, their rating and their available comps. The account may further track any certificates, and the present value thereof, the player may have won as a result of the playing a game according to the present invention. At their smart phone 1212 the player/user sends a request to the cloud service 1204 (perhaps through a previously downloaded application) to receive the status of their available comps such as how many comp points they have and what may be available through redemption of those points (e.g. lodging, cash back, meals or merchandise). The response to the request may present casino promotions, graphics or other advertising to the player/user. The application, to support such a request, would typically require the player/user to enter a PIN. The cloud service 1204 forwards the inquiry to the bonusing servicer 1200 which, in turn, confirms the PIN and retrieves the requested information from the data warehouse 1135 (FIG. 11) or player tracking CMS/CMP server 1137.

Alternatively the data may be stored in the cloud service 1204 and routinely updated from the data warehouse 1135 or player tracking CMS/CMP server 1137. In this instance the request would be responded to from data residing with the cloud service 1204. The information is formatted by the cloud server 1204 application and delivered to the player/user. The delivery may be formatted based upon the player/user's device operating system (OS), display size or the like.

The cloud service 1204 may also host game applications to provide virtual instances of games for free, promotional, or where permitted, P2P (Pay to Play) supported gaming. Third party developers may also have access to placing applications with the cloud service 1204 through, for example a national operations center (for example, Bally NOC 1214). A game software manufacturer such as Bally Gaming, Inc. may also provide game applications on its own or on behalf of the casino enterprise.

Other media such as advertising, notices (such as an upcoming tournament) may also be provided to the cloud service 1204. When a player/user accesses the cloud service 1204 certain media may be delivered to the player/user in a manner formatted for their application and device.

Although the description above contains many specificities, these should not be construed as limiting the scope of the invention but as merely providing an illustration of the presently preferred embodiment of the invention. Thus the scope of this invention should be determined by the appended claims and their legal equivalents.

What is claimed is:

1. A distributed computer system comprising:
at least two processors, each processor including:
at least one process including at least one thread; and
a network server;
a host module in the at least one thread in a first processor of the at least two processors;
a client module in the at least one thread in a second processor of the at least two processors; and
a network coupling the respective network servers in the at least two processors; wherein:
the host module registers with the system via the network server in the first processor;
the client module on the second processor establishes a connection with the host module on the first processor; and
the host module and the client module communicate through the established connection.

2. The system of claim 1 wherein the host module registers by:
providing data representing the host module to the network server in the first processor; and
the network server in the first processor receives the host module representative data and broadcasts that data to the network server in the respective at least two processors.

3. The system of claim 1 wherein the client module establishes a connection by:
providing data representing the client module to the network server on the second processor;
the network server on the second processor sends the client representative data to the network server on the first processor;
the network server on the first processor sends the client representative data to the host module; and
the host module enables communication with the client module.

4. The system of claim 1 wherein the host module and the client module communicate by:
a first module being one of the host module and the client module generates a message containing message related data for a second module being the other one of the host module and the client module;
the first module sends the message to a first network server being the network server in the processor containing the first module;
the first network server sends the message to the a second network server being the network server in the processor containing the second module;
a second network server sends the message to the second module; and
the second module receives and processes the message.

5. The system of claim 4 wherein:
the first module is the client module; and
the second module if the host module.

6. The system of claim 1 wherein the network is an Ethernet network.

7. The system of claim 6 wherein the network contains wired links or wireless links or both

8. A distributed gaming system comprising:
a gaming server including a first processor including:
at least one process including at least one thread; and
a network server;
a gaming client including a second processor including:
at least one process including at least one thread; and
a network server;
a host module in the at least one thread in the processor in the gaming server;
a client module in the at least one thread in the processor in the gaming client; and
a network coupling the respective network servers in the at least two processors; wherein:
the host module registers with the system via the network server in the first processor;
the client module on the second processor establishes a connection with the host module on the first processor; and
the host module and the client module communicate through the established connection.
